(19) United States
(12) Patent Application Publication
(10) Pub. No.: US 2012/0135380 A1
(43) Pub. Date: May 31, 2012

(54) IMPLANT ANALOG

(76) Inventor: Ady Palti, Baden-Baden (DE)

(21) Appl. No.: 13/263,744

(22) PCT Filed: Apr. 11, 2009
(86) PCT No.: PCT/EP2009/002704

§ 371 Date: Feb. 15, 2012

(51) Int. Cl. A61C 13/34

(52) U.S. Cl. 433/213

(57) ABSTRACT

The invention relates to an implant analog for placing in a jaw model for modeling a dental prosthesis by means of the jaw model. Said analog comprises a sleeve extending in an axial direction and comprising an axial inner bore having an internal thread for threading in a fastening screw for fastening a post to the implant analog, wherein the post is provided for fastening a dental prosthesis. According to the invention, the sleeve comprises a self-tapping external thread for threading in the implant analog into a jaw model. The invention further relates to a method for applying such implant analogs and an implant system having such implant analogs.

The invention relates to an implant analog for insertion into a jaw model for modeling a tooth prosthesis by means of the jaw model, said implant analog comprising a sleeve extending in an axial direction, which sleeve has an axial inner bore with an internal thread for screwing in a fastening screw for fastening a post to the implant analog, the post being provided for fastening a tooth prosthesis. The invention is further directed to a method for applying such implant analogs, and to an implant system having such implant analogs.

Tooth implants are foreign bodies inserted into the jaw bone. The subsidiary field of dentistry concerned with the implantation of tooth implants into the jaw bone is referred to as implantology. By virtue of their being able to be used as supports for a tooth replacement, tooth implants assume the function of artificial tooth roots. A drilling jig is used to drill the holes for fitting the tooth implants into the jaw.

The technique of replacing a lost tooth with a tooth implant, and with a tooth prosthesis or bridge secured on the latter, has by now become widely accepted. Use is made of an implant produced from ceramic compound or metal and anchored in the bone, which implant is known as the implant root and on which the artificial tooth crown is fastened. For this purpose, a bore for the implant root has to be introduced into the jaw at the location of the lost tooth.

A complete artificial implanted tooth replacement generally comprises the following three parts:
An artificial root, the so-called bone part, jaw implant or implant.
A connecting part, which is referred to, for example, as attachment part, prosthetic part, attachment post, post, pier, abutment or bone stump. It is connected to the bone part, generally by being screwed in, and supports the actual prosthesis.
The prosthesis, for example an artificial tooth crown, bridge or another prosthesis.

Since the artificial tooth crown is intended to merge harmoniously into the dentition and since the implant root is to have the greatest possible diameter, in order to better absorb mastication pressure, and since the available bone in the jaw is limited, it is necessary for the position and angular orientation of the drilled hole for the implant to be accurately determined in advance and maintained.

To guarantee this, a drilling jig is usually first set up which, at the predetermined location, has a drill cylinder which is adjusted in terms of angular position and whose internal diameter corresponds to the diameter of a pilot drill for drilling a hole in the jaw. The drilling jig is worn by the patient while the pilot hole is being drilled. This drilling jig can be produced on the basis of a model (plaster impression) of the patient's jaw or on the basis of image data obtained by imaging, in particular by X-rays, CT (computed tomography), VT (volume tomography), MRI (magnetic resonance imaging) or on the basis of an ultrasound method. Moreover, the information needed to determine the drilling direction and concerning the extent of the jaw bone is obtained by means of imaging, with the possibility of different sectional views through the jaw. Other methods used to measure the jaw in order to produce a drilling jig are, for example, bone mapping, bone measurement with a probe, or other measuring methods. Special planning software can be used for evaluating the image data and for planning the implant.

Drilling jigs are therefore aids that make it easier for the implantologist to make a hole in the jaw bone of a patient, into which hole the implant is to be inserted. The drilling jig has a drill hole which is produced on the jaw model or in planning software and which serves as a guide for the drill when introducing the hole or pilot hole into the jaw bone. The drilled hole should have the correct position and angle.

Before an implant is inserted into a bone, the tooth prosthesis or drilling jig is first of all modeled using the jaw model, which was produced on the basis of an impression of the patient's bite. Such a jaw model is usually made of plaster but can also be produced from plastic. In the prior art, this jaw model is also referred to as the working model or master model.

However, when modeling the tooth replacement using a jaw model, cost factors mean that an expensive bone part is not used, but instead a simpler and less expensive implant analog, which is also referred to as the laboratory implant.

The implant analogs known in the prior art comprise a cylindrical sleeve which is smooth on its outside and which has an inner bore with an internal thread for screwing in a fastening screw and which, at its distal end, has a matching shape for securing the inserted post against twisting, for example an internal hexagon.

The post can be fastened to the sleeve and has, at its lower end, a corresponding mating piece for securing against twisting, for example an external hexagon. The connection between post and sleeve is made by a fastening screw which is guided axially through the post and is screwed into the internal thread in the sleeve.

An implant analog thus corresponds in terms of its function to that of the bone part which, in the final tooth implant, is inserted into the jaw, but it is of a simpler construction because of its temporary use in the plaster model. The following differences generally exist between an implant analog according to the prior art and a jaw implant:
The implant analog is made of an inexpensive, low-strength material, for example of grade 5 or 6 titanium, steel, anodized aluminum or plastic. The jaw implant is made of an expensive, permanently high-strength material, for example grade 4 titanium, zirconium oxide or a ceramic.
The implant analog has a cylindrical outer shape, whereas the jaw implant has a conical outer shape, i.e. it tapers in the proximal direction.
The sleeve of the implant analog is smooth on the outside, whereas the jaw implant has an elaborate thread on the outside of the sleeve, for example a double thread or a progressive thread, or is roughened.

The sleeve of an implant analog according to the prior art is smooth on the outside, because its position is secured in practice by casting or polymerizing in the jaw model. For this purpose, a hole whose diameter is larger than the external diameter of the implant analog is drilled in the jaw model at the predetermined position that corresponds to the position of the later tooth implant in the jaw. The drilled hole is then filled with adhesive and the laboratory implant inserted therein. It has to be fixed in its position until the adhesive has set, hardened or fully polymerized. Thereafter, excess adhesive, which emerges from the drilled hole when the implant analog is inserted, is cleaned from the jaw model. Thereafter, successive laboratory analogs are inserted in a similar way at other required locations, and, when all the implant analogs have been inserted into the jaw model, the tooth replacement and/or drilling jig is modeled.

Proceeding from this, it is an object of the present invention to make available an implant analog for insertion into a jaw model for modeling a tooth prosthesis by means of the jaw model, which implant analog is more advantageous in practice.

According to the invention, this object is achieved by an implant analog with the features of claim 1. Preferred embodiments are set forth in the dependent claims and in the following description with associated drawings.

A further object of the present invention is to make available a method for inserting an implant analog into a jaw model for modeling a tooth prosthesis by means of the jaw model, which method is easy to implement in practice.

According to the invention, this object is achieved by a method with the features of the first additional independent claim. Preferred embodiments are set forth in the dependent claims and in the following description with associated drawings.

A further object of the present invention is to make available an implant system having implant analogs, which implant system is inexpensive and easy to use in practice.

According to the invention, this object is achieved by an implant system with the features of the second additional independent claim. Preferred embodiments are set forth in the dependent claims and in the following description with associated drawings.

Therefore, an implant analog according to the invention for insertion into a jaw model for modeling a tooth prosthesis by means of the jaw model comprises
a sleeve extending in an axial direction,
which sleeve has an axial inner bore with an internal thread for screwing in a fastening screw for fastening a post to the implant analog,
the post being provided for fastening a tooth prosthesis,
   and is characterized in that
the sleeve has a self-tapping external thread for screwing the implant analog into a jaw model.

Therefore, the sleeve of an implant analog according to the invention is not a smooth cylinder on the outside and instead has a self-tapping thread there. This has the following advantages over an implant analog according to the prior art:
The axial positioning of the implant analog can be accurately determined by the screwing-in depth of the thread.
The axial positioning of the implant analog can be changed at any time by screwing into or screwing out of the jaw model, that is to say can be screwed deeper into the jaw model or screwed further out of the jaw model, since it does not have to be firmly polymerized in place.
The lateral position of the implant analog is better defined, since there is no circumferential gap in a drilled hole with a greater diameter, and instead the position of the drilled hole, into which the implant analog is screwed, exactly defines the position of the implant analog.
Preparation and introduction of adhesive are avoided.
The waiting time for the adhesive to harden is avoided.
Cleaning and the removal of excess adhesive that emerges from the drilled hole are avoided.

It has been found that an implant analog of this kind permits optimal, quick and uncomplicated insertion into the jaw model, even though the implant analog is fixed in the jaw model only by its external thread, i.e. without adhesive. Insertion of the implant analog requires less work, and the axial position thereof can be adjusted. By virtue of the fact that the external thread is self-tapping, it is not necessary, prior to screwing in the implant analog, to carry out a separate working step in which a thread is cut into the jaw model for the implant analog.

Accordingly, a method according to the invention for inserting an implant analog into a jaw model for modeling a tooth prosthesis by means of the jaw model is characterized in that an implant analog according to the invention is screwed into the jaw model by means of the self-tapping external thread of the implant analog.

Advantageously, the implant analog is screwed into a locating bore that has been drilled beforehand in the jaw model. Such a locating bore or preliminary bore is particularly expedient for determining the exact position of the implant analog, in order to make it easier to screw in the implant analog or to avoid breaking of the jaw model, in particular when the latter is made of plaster. The diameter of the locating bore can be smaller than or equal to the maximum external diameter of the sleeve. The diameter of the locating bore is preferably the same as or only slightly smaller than the core diameter of the external thread of the sleeve, i.e. the external diameter of the sleeve.

The implant analog can be screwed into the jaw model manually by means of a screwing tool, or it can be screwed in by machine. The screwing-in by machine can be effected either by manual guiding of a corresponding screwing-in machine or by fully automatic screwing-in by means of an automatic machining device into which the jaw model is clamped.

In another advantageous embodiment, independently of the dimensions of the implant which is to be inserted into the real jaw bone and in place of which the implant analog is used in the jaw model, an implant analog having a predefined axial length is screwed into the jaw model, which axial length, independently of the dimensions of the implant to be inserted into the real jaw bone, is uniform for a plurality of different implants.

Accordingly, an implant system according to the invention having implant analogs according to the invention is characterized in that it comprises implant analogs having a predefined axial length which, independently of the dimensions of the implant which is to be inserted into the real jaw bone and in place of which the implant analog is used in the jaw model, is uniform for a plurality of different implants.

The implant analogs according to the invention that belong to an implant system have a uniform and fixed defined length, for example 7 mm or 10 mm. Since the drilling depth in the jaw model is not limited in the same way as in the real jaw bone, it is possible, independently of the post and prosthesis part used, to drill to a uniform depth in the plaster model before the implant analogs are screwed therein with a uniform length. This in turn simplifies practical handling. The hole drilled in the jaw model is preferably slightly deeper than the axial length of the implant analog, for example by a millimeter. By contrast, unlike the implant analogs for the jaw model, the implants used in the jaw have to be made available with stepped lengths in order to permit adjustment to the jaw.

The invention is explained in more detail below on the basis of an illustrative embodiment depicted in the figures. The particular features described therein can be applied individually or in combination with one another in order to create preferred embodiments of the invention. In the drawing:

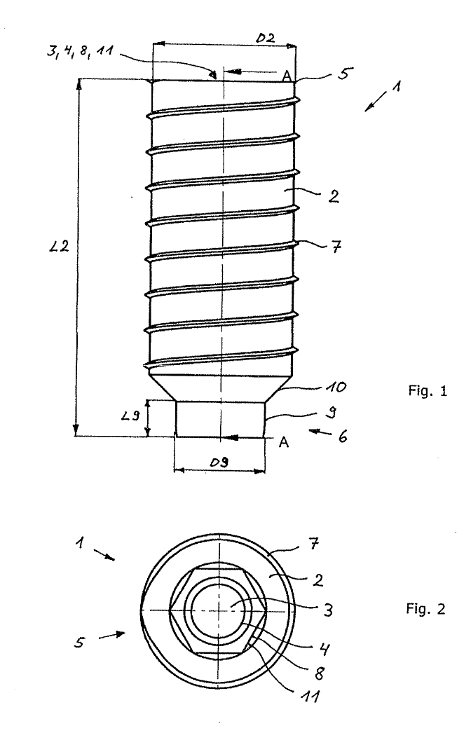

FIG. 1 shows a view of an implant analog according to the invention,

FIG. 2 shows a plan view of the distal end of the implant analog from FIG. 1, and

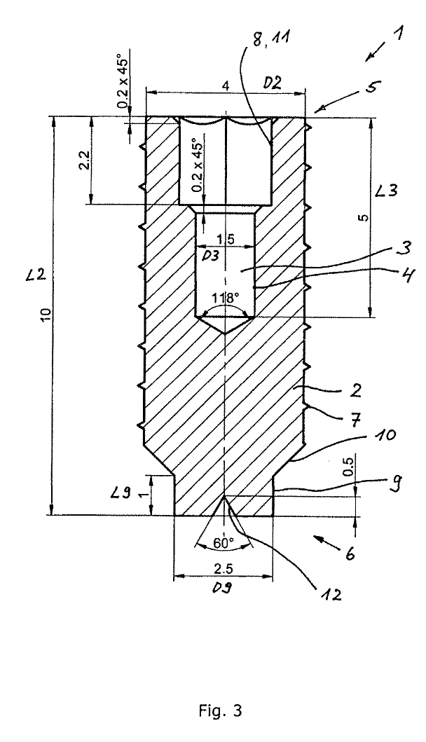

FIG. 3 shows an axial longitudinal section A-A through the implant analog from FIG. 1.

FIG. 1 shows a view of an illustrative embodiment of an implant analog 1 according to the invention which can be inserted into a jaw model for modeling a tooth prosthesis. The implant analog 1 comprises a sleeve 2 extending in an axial direction, which sleeve 2 has an axial inner bore 3 (see FIG. 3) with an internal thread 4 for screwing in a fastening screw for fastening a post to the implant analog 1. The inner bore extends from the distal end 5 of the implant analog 1 in the direction of the proximal end 6 of the implant analog 1.

Before tooth implants are inserted, it is first of all necessary to fix the positions that the implants are intended to assume in the jaw bone. For this purpose, an impression is taken of the area of the oral cavity containing the edentulous sites and, if appropriate, adjacent teeth or rows of teeth. From this impression, a jaw model is then produced that corresponds to the area of the oral cavity into which the implants are intended to be inserted. The positions of the implants are then fixed on this jaw model. In a subsequent step, a jig, e.g. a drilling jig, is prepared for the jaw model. Positioning aids, which are used to guide the surgical tools when working the bone, are introduced into this jig at the implantation sites.

For modeling the dental situation and the implants on the basis of the jaw model, laboratory implants are inserted into the jaw model, on which laboratory implants the posts and tooth prostheses are fastened and oriented.

To fasten the laboratory implant 1 according to the invention in the jaw model, the sleeve 2 has a self-tapping external thread 7 for screwing the implant analog 1 into a jaw model. For inserting and fixing the implant analog 1 in the jaw model, the sleeve 2 has a self-tapping external thread 7 with which the implant analog 1 is screwed into the jaw model. The sleeve 2 and the external thread 7 can in particular be designed for screwing into a jaw model made of plaster or of plastic. The sleeve 2 and the external thread 7 are preferably designed for screwing into a locating bore that has been drilled beforehand in the jaw model.

It has proven particularly advantageous if the sleeve 2 and the external thread 7 are designed in such a way that the implant analog 1 is fixed in the jaw model only by the external thread 7, i.e. without adhesive. The implant analog 1 is not cast, adhesively bonded or polymerized into the jaw model, but simply screwed into the jaw model, which means that, when the implant analog 1 has been introduced, it is not necessary to wait for a long time for adhesive to harden, and instead the fitting or modeling can be continued quickly without waiting, which is advantageous particularly in the case of a plurality of implant analogs 1 that are introduced together into a jaw model. For this purpose, the positioning aid 1 is provided with the external thread 7.

In FIGS. 1 and 3, the distal end 5 of the sleeve 2 is at the top and the proximal end 6 at the bottom. The implant analog 6 is screwed into the jaw model with the proximal end 6 leading. It is favorable if the implant analog 1 additionally has a tool socket 8 into which a tool, for example an Allen key, for example a hexagon wrench, can engage, in order to screw the implant analog 1 into the jaw model. The tool socket 8 is preferably located at the distal end 5 of the sleeve 2.

The implant analog 1 is preferably designed as a one-piece component.

To be able to easily mount the implant analog 1 and the sleeve 2 in any desired depth or any desired position in the jaw model, it is advantageous if the sleeve 2 and the external thread 7 are designed in such a way that the implant analog 1 can be screwed along its entire length into the jaw model. In this case, the implant analog 1 therefore has no part protruding radially beyond the external diameter D2 of the sleeve 2 and limiting the depth of insertion.

It is also advantageous if the sleeve 2 has a constant external diameter D2 along its entire length. In other embodiments, however, it may also be expedient if the sleeve 2 is slightly conical, i.e. tapers slightly from the distal end 5 toward the proximal end 6.

The external thread 7 can extend over the entire axial cylindrical outer surface of the sleeve 2. In some embodiments, it may also be expedient if the sleeve 2 has, at its proximal end 6, a front portion 9 with a smaller external diameter D9 than the sleeve 2. At the proximal end 6, therefore, the laboratory implant 1 has a smaller diameter D9, and the transition area is formed, for example, by an annular shoulder or preferably by a bevel 10. The transition from the larger external diameter D2 of the sleeve to the smaller external diameter D9 of the front portion 9 can preferably be designed as a beveled tapering of the sleeve 2.

The tapering of the sleeve 2 to a smaller external diameter D9 in the area of the front portion 9 has the advantage that the laboratory implant 1 can better be inserted into a locating bore in a jaw model, which is generally made of plaster. In addition to the front portion 9 being able to serve as an insertion aid and the bevel 10 as a centering aid, a further advantage is that the locating bores which are provided in the plaster model and into which the laboratory implants 1 are screwed can be blown out only poorly with compressed air and, consequently, plaster residues often remain at the edge of the bottom of the locating bores. The tapering of the sleeve 2 at its proximal end 6 means that, when the implant analog 1 is screwed into the locating bore of the jaw model, a small annular gap remains there in which the plaster residues that cannot be blown out are able to gather, without forming, at the proximal end of the laboratory implant 1, an abutment limiting the screwing depth of the sleeve 2. In this way, the sleeve 2 can be screwed into the jaw model to a defined depth.

In advantageous embodiments, the external diameter D9 of the front portion 9 is between 10% and 90%, preferably between 20% and 80%, particularly preferably between 30% and 70%, of the diameter D2 of the sleeve 2, for example at its distal end 6. The axial length L9 of the front portion 9 is advantageously between 1% and 20%, preferably between 2% and 15%, particularly preferably between 3% and 10%, of the axial length L2 of the sleeve 2.

Unlike the tooth implant inserted into the jaw bone at a location after the modeling has been completed, the material of the implant analog 1 does not have to meet high demands. In advantageous embodiments, it can be made of plastic, titanium, grade 5 titanium, grade 6 titanium, steel or anodized aluminum.

The tool socket 8 can be seen particularly clearly in FIG. 2, which shows a plan view of the distal end 5 of the implant analog 1 from FIG. 1. The socket 8 is designed for example as an internal hexagon. Moreover, the sleeve 2 has, at its distal end 5, a receiving opening 11 with a matching shape corresponding to the proximal end of a post that can be inserted therein. The receiving opening 11 is preferably designed in such a way that the corresponding proximal end of a post that can be inserted therein is inserted in a manner secure against twisting. The securing against twisting between laboratory implant 1 and post can be effected in different ways, for example by an internal hexagon in the laboratory implant 1 and a corresponding external hexagon of the post, by any desired matching shape, by a toothed arrangement, or in some other way. The receiving opening 11 securing the post against twisting can also form the tool socket 8 at the same time.

In particular embodiments, the implant analog 1 can be designed in such a way that the receiving opening 11 is round, such that the corresponding end of a post inserted therein is freely rotatable. However, provision can also be made that the post, at the end thereof directed toward the laboratory implant 1, that is to say the proximal end, is round, such that it is freely rotatable in the receiving opening 11, provided for example with an internal hexagon, of the laboratory implant 1. This has the advantage that the post can be oriented freely in terms of its angle of rotation.

In modified embodiments of a post that can be used with the laboratory implant 1, the post can be kinked in order to obtain an inclined position, that is to say the pin that engages in the receiving opening 11 of the laboratory implant 1 is at an angle to the axial direction of the post. In this case too, the fastening is effected by means of a fastening screw guided through the inner bore, but the bore, because of the kink, can no longer extend axially in the post.

FIG. 3 shows an axial longitudinal section A-A through the implant analog 1 from FIG. 1. Where dimensions are indicated in this figure, these dimensions are in mm. The receiving opening 11 at the distal end 5 of the sleeve 2 can be seen clearly in FIG. 3, with a matching shape corresponding to the proximal end of a post that can be inserted therein. The post is fastened to the laboratory implant 1 by a fastening screw, which is screwed into the inner bore 3.

The axial length L3 of the inner bore 3 is advantageously between 10% and 90%, preferably between 20% and 80%, particularly preferably between 30% and 70%, of the axial length L2 of the sleeve 2.

The diameter D3 of the inner bore 3 is advantageously between 10% and 90%, preferably between 20% and 80%, particularly preferably between 30% and 70%, of the external diameter D2 of the sleeve 2.

The external diameter D2 of the sleeve 2 is advantageously between 3 mm and 8 mm, preferably between 3.5 mm and 7 mm, particularly preferably between 4 mm and 6 mm. The axial length L2 of the sleeve 2 is advantageously between 5 mm and 30 mm, preferably between 7 mm and 20 mm, particularly preferably between 8 mm and 15 mm.

It will also be seen in FIG. 3 that the implant analog 1 or the sleeve 2 or the front portion 9 has a depression 12 at the middle of the proximal end face. This depression 12 can serve in particular to receive an adhesive with which the bottom of the sleeve 2 can be secured on the bottom of the locating bore or preliminary bore into which it is screwed. However, the depression 12 can also have the same function as the tapering of the sleeve 2 in a front portion 9, namely that of creating a space for receiving plaster residues not blown out from the locating bore or preliminary bore.

As is shown, the external thread 7 can advantageously extend over the entire axial cylindrical outer surface of the sleeve 2. In some applications, however, it may also be advantageous if the external thread 7 does not extend over the entire axial cylindrical outer surface of the sleeve 2 but only over one or more partial areas.

In a further embodiment, provision can be made that the external diameter of the external thread 7 is between 0.01 mm and 1.5 mm larger, preferably between 0.02 mm and 1.0 mm larger, particularly preferably between 0.03 mm and 0.5 mm larger, than the core diameter of the external thread 7, that the lead and/or the pitch of the external thread 7 is between 0.5 mm and 4 mm, preferably between 0.8 mm and 2 mm, that the external thread 7 is a trapezoidal thread, that the thread turns of the trapezoidal thread have flanks shaped as pointed cones, that the flanks shaped as pointed cones have a flank angle of between 40° and 80°, preferably of between 50° and 70°, to each other, that the thread teeth have a flat, or that the flat has a width of between 0.03 mm and 0.2 mm, preferably of between 0.05 mm and 0.1 mm.

### LIST OF REFERENCE SIGNS

1 implant analog
2 sleeve
3 inner bore
4 internal thread
5 distal end
6 proximal end
7 external thread
8 tool socket
9 front portion
10 bevel
11 receiving opening
12 depression
L2 length of 2
L3 length of 3
L9 length of 9
D2 external diameter of 2
D3 diameter of 3
D9 external diameter of 9

1. An implant analog for insertion into a jaw model for modeling a tooth prosthesis by means of the jaw model, said implant analog comprising
a sleeve extending in an axial direction,
which sleeve has an axial inner bore with an internal thread for screwing in a fastening screw for fastening a post to the implant analog,
the post being provided for fastening a tooth prosthesis,
characterized in that
the sleeve has a self-tapping external thread for screwing the implant analog into a jaw model.

2. The implant analog as claimed in claim 1, characterized in that the sleeve and the external thread are designed for screwing into a locating bore that has been drilled beforehand in the jaw model.

3. The implant analog as claimed in claim 1, characterized in that the sleeve and the external thread are designed for screwing into the jaw model manually by means of a screwing tool.

4. The implant analog as claimed in claim 1, characterized in that the sleeve and the external thread are designed for screwing into the jaw model by machine.

5. The implant analog as claimed in claim 1, characterized in that the sleeve and the external thread are designed for screwing into a jaw model made of plaster.

6. The implant analog as claimed in claim 1, characterized in that the sleeve and the external thread are designed for screwing into a jaw model made of plastic.

7. The implant analog as claimed in claim 1, characterized in that the sleeve and the external thread are designed in such a way that the implant analog is fixed in the jaw model only by the external thread, i.e. without adhesive.

8. The implant analog as claimed in claim 1, characterized in that the sleeve and the external thread are designed in such a way that it can be screwed along its entire length into the jaw model.

9. The implant analog as claimed in claim 1, characterized in that the external diameter of the sleeve is between 3 mm and 8 mm, preferably between 3.5 mm and 7 mm, particularly preferably between 4 mm and 6 mm.

10. The implant analog as claimed in claim 1, characterized in that the axial length of the sleeve is between 5 mm and 30 mm, preferably between 7 mm and 20 mm, particularly preferably between 8 mm and 15 mm.

11. The implant analog as claimed in claim 1, characterized in that the sleeve has a constant external diameter along its entire length.

12. The implant analog as claimed in claim 1, characterized in that the sleeve has, at its proximal end, a front portion with a smaller external diameter.

13. The implant analog as claimed in claim 12, characterized in that the external diameter of the front portion is between 10% and 90%, preferably between 20% and 80%, particularly preferably between 30% and 70%, of the diameter of the sleeve, for example at its distal end.

14. The implant analog as claimed in claim 12, characterized in that the axial length of the front portion is between 1% and 20%, preferably between 2% and 15%, particularly preferably between 3% and 10%, of the axial length of the sleeve.

15. The implant analog as claimed in claim 12, characterized in that the transition from the larger external diameter of the sleeve to the smaller external diameter of the front portion is designed as a beveled tapering of the sleeve.

16. The implant analog as claimed in claim 1, characterized in that the sleeve has a depression at its proximal end face.

17. The implant analog as claimed in claim 1, characterized in that the external thread extends over the entire axial cylindrical outer surface of the sleeve.

18. The implant analog as claimed in claim 1, characterized in that the external diameter of the external thread is between 0.01 mm and 1.5 mm larger, preferably between 0.02 mm and 1.0 mm larger, particularly preferably between 0.03 mm and 0.5 mm larger, than the core diameter of the external thread.

19. The implant analog as claimed in claim 1, characterized in that the lead and/or the pitch of the external thread is between 0.5 mm and 4 mm, preferably between 0.8 mm and 2 mm.

20. The implant analog as claimed in claim 1, characterized in that the external thread is a trapezoidal thread.

21. The implant analog as claimed in claim 20, characterized in that the thread turns of the trapezoidal thread have flanks like pointed cones.

22. The implant analog as claimed in claim 21, characterized in that the flanks like pointed cones have a flank angle of between 40° and 80°, preferably of between 50° and 70°, to each other.

23. The implant analog as claimed in claim 21, characterized in that the thread teeth have a flat.

24. The implant analog as claimed in claim 23, characterized in that the flat has a width of between 0.03 mm and 0.2 mm, preferably of between 0.05 mm and 0.1 mm.

25. The implant analog as claimed in claim 1, characterized in that the sleeve has, at its distal end, a receiving opening with a matching shape corresponding to the proximal end of a post that can be inserted therein.

26. The implant analog as claimed in claim 25, characterized in that the receiving opening is designed such that the corresponding proximal end of a post insertable therein is inserted in a manner secure against twisting.

27. The implant analog as claimed in claim 25, characterized in that the receiving opening is round, such that the corresponding end of a post inserted therein is freely rotatable.

28. The implant analog as claimed in claim 1, characterized in that it is made of plastic, titanium, grade 5 titanium, grade 6 titanium, steel or anodized aluminum.

29. A method for inserting an implant analog into a jaw model for modeling a tooth prosthesis by means of the jaw model, characterized in that an implant analog as claimed in claim 1 is screwed into the jaw model by means of the self-tapping external thread of the implant analog.

30. The method as claimed in claim 29, characterized in that the implant analog is screwed into a locating bore that has been drilled beforehand in the jaw model.

31. The method as claimed in claim 29, characterized in that the implant analog is screwed into the jaw model manually by means of a screwing tool.

32. The method as claimed in claim 29, characterized in that the implant analog is screwed into the jaw model by machine.

33. The method as claimed in claim 29, characterized in that the implant analog is fixed in the jaw model only by its external thread, i.e. without adhesive.

34. The method as claimed in claim 29, characterized in that, independently of the dimensions of the implant which is to be inserted into the real jaw bone and in place of which the implant analog is used in the jaw model, an implant analog having a predefined axial length is screwed into the jaw model, which axial length, independently of the dimensions of the implant to be inserted into the real jaw bone, is uniform for a plurality of different implants.

35. An implant system comprising implant analogs as claimed in claim 1, characterized in that it comprises implant analogs having a predefined axial length which, independently of the dimensions of the implant which is to be inserted into the real jaw bone and in place of which the implant analog is used in the jaw model, is uniform for a plurality of different implants.
